(19) United States
(12) Patent Application Publication
(10) Pub. No.: US 2006/0154125 A1
(43) Pub. Date: Jul. 13, 2006

(54) Stack for fuel cell and fuel cell system with the same

(76) Inventors: Young-Seung Na, Yongin-si (KR); Jun-Won Suh, Suwon-si (KR)

Correspondence Address: CHRISTIE, PARKER & HALE, LLP, PO BOX 7068, PASADENA, CA, 91109-7068, US

(21) Appl. No.: 11/329,825

(22) Filed: Jan. 10, 2006

(30) Foreign Application Priority Data
Jan. 10, 2005 (KR) 10-2005-0002116

(51) Int. Cl. H01M 8/04; H01M 8/02; H01M 8/24

(52) U.S. Cl. 429/26; 429/38

(57) ABSTRACT

A fuel cell stack includes at least one electric generator with a membrane electrode assembly and separators placed at both sides of the membrane electrode assembly. A plurality of common passages are arranged at a surface of at least one of the separators to permit the flow of oxygen and a coolant. A guide is formed at an inlet of the common passage to guide the oxygen and the coolant into the common passage.

### CROSS-REFERENCE TO RELATED APPLICATION

This application claims priority to and the benefit of Korean Patent Application No. 10-2005-0002116 filed in the Korean Intellectual Property Office on Jan. 10, 2005, the entire content of which is incorporated herein by reference.

### FIELD OF THE INVENTION

The present invention relates to a fuel cell, and in particular, to a stack for a fuel cell.

### BACKGROUND

Generally, a fuel cell is an electric power system which directly converts chemical energy into electrical energy through the electrochemical reaction of hydrogen in a hydrocarbon-based material such as methanol, ethanol or natural gas with oxygen such as from air as the fuel. Particularly, the fuel cell is characterized in that it can simultaneously use the electricity generated due to the electrochemical reaction of a fuel gas and an oxidation gas, and the heat incidental thereto without performing a combustion process.

Depending upon the kinds of electrolytes to be used, fuel cells may be classified as phosphate fuel cells which operate at 150˜200° C., molten carbonate fuel cells which operate at 600˜700° C., solid oxide fuel cells which operate at 1,000° C. or more, or polymer electrolyte or alkali fuel cells which operate at ambient temperatures or at 100° C. or less. The different fuel cells operate based on the same fundamental principles, but are distinguished by the kind of fuels used, the operation temperatures, and the catalysts and electrolytes used.

Among fuel cells, polymer electrolyte membrane fuel cells (PEMFCs) have been recently developed with excellent output characteristics, lower operation temperatures, and rapid starting and short response time characteristics. A PEMFC may be widely used as a mobile power source for cars, a distributed power source for household and public buildings, and a small power source for electronic appliances.

The PEMFC has a basic system structure with a fuel cell body called a stack (referred to hereinafter as the stack), a fuel tank, and a fuel pump for supplying a fuel from the fuel tank to the stack. The PEMFC may further include a reformer for reforming the fuel to hydrogen which is supplied to the stack.

With the above-structured PEMFC, the fuel stored in the fuel tank is generally supplied to the reformer by a fuel pump, and the reformer reforms the fuel to generate hydrogen. The stack electrochemically reacts the hydrogen with oxygen, thereby producing electrical energy.

A fuel cell may also be provided as a direct methanol fuel cell (DMFC) in which a liquid fuel such as methanol is supplied directly to the stack. Unlike a PEMFC, a DMFC has no reformer.

In a fuel cell system, the stack for substantially generating electricity has a laminated structure with several to several tens of unit cells each comprising a membrane electrode assembly (MEA) and a bipolar plate (referred to hereinafter as a separator).

When heat is generated in the stack due to the driving thereof, the performance capacity of the MEA may be deteriorated, and in a serious case, the stack may suffer serious damage.

In order to prevent such damage, an air or water cooler may be provided with the fuel cell system to continually dissipate the heat generated from the stack during the operation thereof.

For instance, air cooling may be used such that cooling air is ventilated through a passage formed between the stack cells to dissipate the heat generated from the stack.

However, with a conventional structure, much of the cooling air does not enter the inlet of the passage. Consequently, the cooling air is diffused external to the passage so that, the cooling efficiency of the stack is deteriorated.

Furthermore, with a conventional stack, when the fuel is supplied to the passage formed by the separators of the cells, it may not properly enter the inlet of the passage. Therefore, the required amount of fuel is not supplied to the stack so that the capacity of the stack is deteriorated.

### SUMMARY OF THE INVENTION

It is an object of the present invention to provide a fuel cell stack which has an improved passage structure to better introduce a coolant, an oxidant, or a fuel to the fuel cell stack, and a fuel cell system including such an improved stack.

This and other objects may be achieved by a fuel cell stack with the following features, and a fuel cell system based on the stack.

According to one aspect of the present invention, a fuel cell stack includes an electric generator for generating electrical energy through reacting hydrogen with oxygen. The electric generator receives the oxygen and a coolant through a single passage, and the passage has an inlet with a sectional area and an outlet with a sectional area, wherein the sectional area of the inlet is larger than the sectional area of the outlet.

According to one embodiment, air is used as both the oxygen source and the coolant.

According to another aspect of the present invention, a fuel cell stack includes an electric generator with a membrane electrode assembly and separators placed at both sides of the membrane electrode assembly. The electric generator has a plurality of common passages arranged at a surface of at least one of the separators through which oxygen and a coolant pass, and a guide formed at an inlet of each common passage to guide the oxygen and the coolant into each common passage.

As mentioned above according to one embodiment, air is used as both the oxygen source and the coolant.

Each common passage may be formed as a channel at a surface of the separator, contacting the membrane electrode assembly.

The common passage may proceed from one end of the separator to the opposite end thereof.

The guide may include at least one inclined portion formed at the inlet to direct flow into the inlet.

According to another aspect of the present invention, a fuel cell stack includes a plurality of electric generators, at least one cooling passage formed between the neighboring electric generators, and a guide formed at an inlet of the cooling passage to guide the coolant into the cooling passage.

The electric generator may have a membrane electrode assembly, and separators placed at both sides of the membrane electrode assembly. The cooling passage may be formed at the separator.

The cooling passage may be formed by engaging channels formed at a surface of the separator with channels formed at a surface of an adjacent separator.

The cooling passage may be formed at a cooling plate disposed between the electric generators such that the cooling passage penetrates through the cooling plate.

According to another aspect of the present invention, an electric generator assembly for a fuel cell includes an electric generator with a membrane electrode assembly and separators placed at both sides of the membrane electrode assembly. The electric generator of this embodiment has a fuel passage formed on a surface of at least one of the separators through which a fuel may flow, and a guide formed at an inlet of the fuel passage to guide the fuel into the fuel passage.

The guide may be formed with at least one inclining wall to direct the flow of fuel to the inlet.

According to another aspect of the present invention, a fuel cell system includes a stack, a fuel supplier for supplying a fuel to the stack, and an oxygen supplier. The stack has an electric generator with a membrane electrode assembly, separators placed at both sides of the membrane electrode assembly, a plurality of common passages arranged at a surface of at least one of the separators through which oxygen and a coolant pass, and a guide formed at an inlet of each common passage to guide the oxygen and the coolant into each common passage. The oxygen supplier supplies oxygen to each common passage.

According to another aspect of the present invention, a fuel cell system includes a stack with a plurality of electric generators, a fuel supplier for supplying a fuel to the stack, an oxygen supplier for supplying oxygen to the stack, and a coolant supplier for supplying a coolant to the stack. The stack has a cooling passage formed between the electric generators through which the coolant passes, and a guide formed at an inlet of the cooling passage to guide the coolant into the cooling passage.

According to another aspect of the present invention, a fuel cell system includes the electric generator assembly, and a fuel supplier for supplying a fuel to the electric generator assembly.

### BRIEF DESCRIPTION OF THE DRAWINGS

The above and other advantages of the present invention will become more apparent by describing preferred embodiments thereof in detail with reference to the accompanying drawings in which:

FIG. 1 is a schematic diagram of a fuel cell system according to an embodiment of the present invention;

FIG. 2 is an exploded perspective view of a fuel cell stack according to an embodiment of the present invention;

FIG. 3 is a sectional view of a separator of the stack shown in FIG. 2;

FIG. 4 is a combination sectional view of the stack shown in FIG. 2;

FIG. 5 is a front view of a passage of a separator for the stack shown in FIG. 2;

FIG. 6 is a schematic diagram of a fuel cell system according to another embodiment of the present invention;

FIG. 7 is a schematic diagram of a fuel cell system according to another embodiment of the present invention;

FIG. 8 is an exploded perspective view of a stack according to another embodiment of the present invention;

FIG. 9 is a combination sectional view of the stack shown in FIG. 8;

FIG. 10 is a front view of a cooling passage of a separator for the stack shown in FIG. 8;

FIG. 11 is an exploded perspective view of a stack according to another embodiment of the present invention;

FIG. 12 is a front view of a cooling passage of a cooling plate for the stack shown in FIG. 11;

FIG. 13 is a schematic diagram of a fuel cell system according to another embodiment of the present invention; and

FIG. 14 is a perspective view of a separator of the fuel cell system shown in FIG. 13.

### DETAILED DESCRIPTION

The present invention will be described more fully hereinafter with reference to the accompanying drawings in which preferred embodiments of the invention are shown. However, the present invention may be embodied in various different forms, and is not limited to the specific embodiments illustrated.

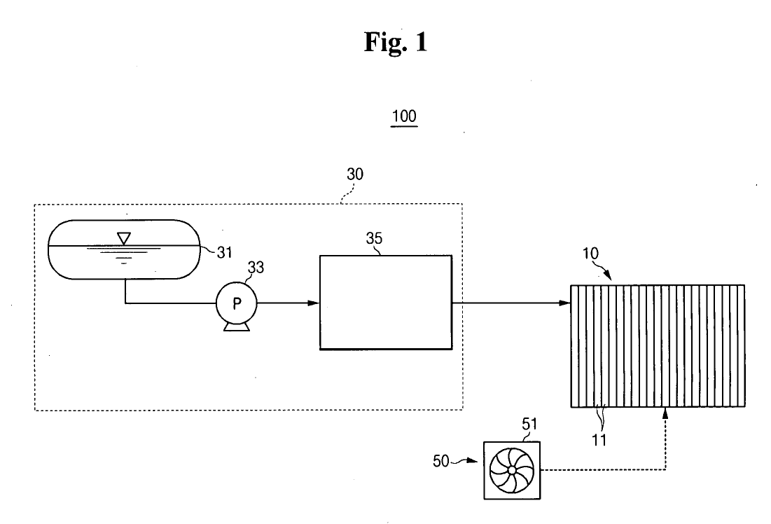

FIG. 1 is a schematic diagram of a fuel cell system according to an embodiment of the present invention.

As shown in FIG. 1, the fuel cell system 100 is based on the structure of a polymer electrolyte membrane fuel cell (PEMFC) where hydrogen is produced by reforming a fuel, and the hydrogen electrochemically reacts with an oxidation gas to generate electrical energy.

With the fuel cell system 100, the term “fuel” is intended to collectively refer to any liquid or gaseous fuel containing hydrogen such as methanol, ethanol or natural gas, which is reformed to produced hydrogen. According to the present embodiment, a liquid fuel is used.

With the fuel cell system 100, the oxidant may be stored as oxygen at a separate storage means or the oxygen in air may be used as an oxidation gas for reacting with the hydrogen. In the present embodiment, air is used as the oxidation gas in the fuel cell system 100.

The fuel cell system 100 according to the present embodiment basically includes a plurality of electric generators 11 for reacting hydrogen with oxygen to generate electrical energy, a fuel supplier 30 for generating hydrogen from the fuel and supplying the hydrogen to the electric generators 11, and an oxygen supplier 50 for supplying air to the electric generators 11.

Each electric generator is connected to the fuel supplier 30 and the oxygen supplier 50 to receive hydrogen from the fuel supplier 30 and air from the oxygen supplier 50 to electrochemically react the hydrogen with oxygen from the air to generate electrical energy.

In this embodiment, a plurality of the electric generators 11 are arranged and assembled adjacent one another to form a stack 10.

In operation, the stack 10 dissipates the heat generated from the electric. generators 11 with the air supplied from the oxygen supplier 50.

The fuel supplier 30 includes a fuel tank 31 for storing a liquid fuel, a fuel pump 33 connected to the fuel tank 31 to discharge the fuel from the fuel tank 31, and a reformer 35 disposed between the fuel pump 33 and the stack 10 to receive the fuel from the fuel tank 31 and generate a hydrogen-containing reforming gas from the fuel. The reformer 35 supplies the reforming gas to the electric generators 11.

In a typical fuel supplier 30, the reformer 35 generates the reforming gas from the fuel using a reforming catalyst based on a thermal source such as steam reforming, partial oxidation or a magnetic thermal reaction. The reformer 35 may also reduce the concentration of carbon monoxide in the reforming gas through a catalytic reaction such as water gas conversion, selective oxidation, or hydrogen purification using a separator film. Such a reformer 35 is commonly used with a PEMFC, and hence, a detailed explanation is omitted.

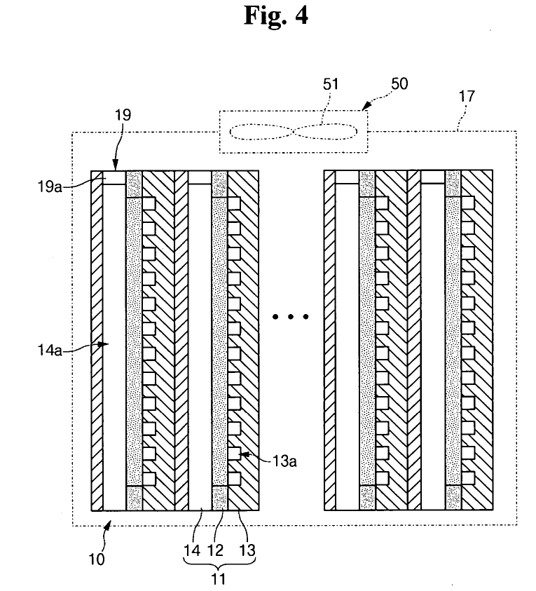

The oxygen supplier 50 is connected to the stack 10, and has a fan 51 for supplying atmospheric air to the electric generators 11. Referring to FIG. 4, the fan 51 may be installed in a housing 17 wholly covering the stack 10 to diffuse the air over the entire area of the stack 10.

The fuel cell system 100 according to the present embodiment is not provided with a separate structure for cooling the stack 10 as the oxygen supplier 50 performs that function. According to this embodiment, a portion of the air supplied from the oxygen supplier 50 is used in the electrochemical reaction of the electric generators 11 and a portion is used to cool the stack 10 and dissipate the heat generated from the electric generators 11. This operation will be further explained below.

When hydrogen is supplied to the electric generators 11 from the fuel supplier 30 and air from the oxygen supplier 50, the heat generated from the electric generators 11 is dissipated using the air, and at the same time, the electric generators 11 electrochemically react hydrogen in the reforming gas with oxygen in the air, thereby generating electrical energy, water and heat.

For a fuel cell system 100 according to the present invention which is of the DMFC type in which a liquid fuel is directly supplied to the stack to produce electricity, there is no reformer as is required for a PEMFC type. A PEMFC-type fuel cell system with a reformer 35 according to an embodiment of the present invention will be now exemplified and explained, but the present invention is not limited thereto. Furthermore, the stack 10 will be now explained with reference to the appended drawings.

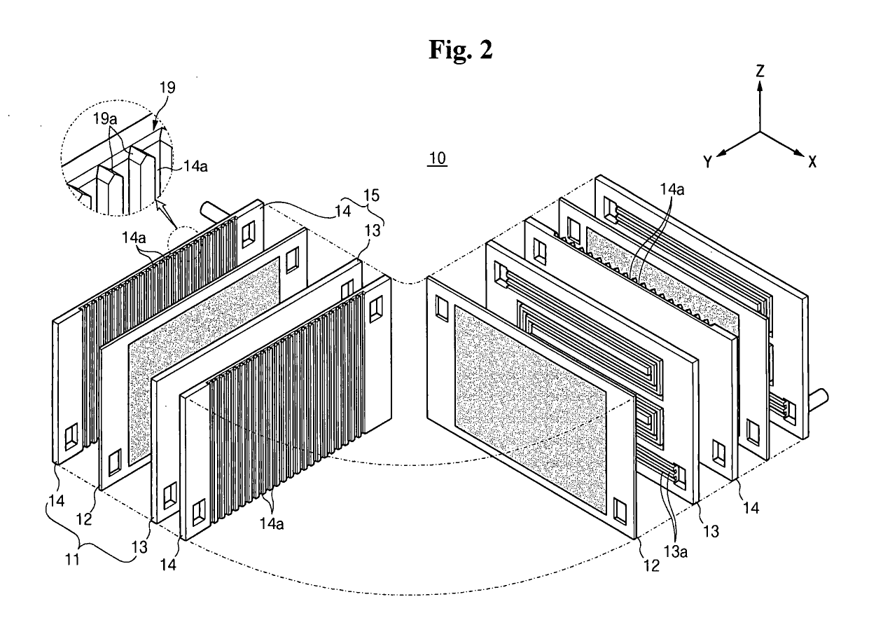

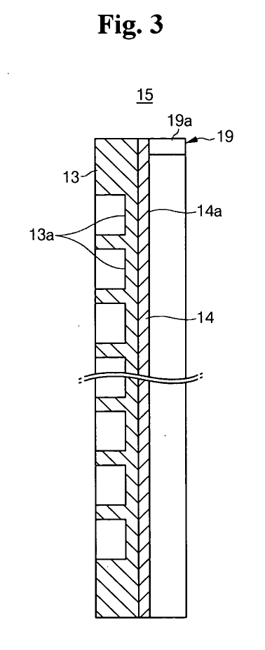

FIG. 2 is an exploded perspective view of a fuel cell stack with separators according to an embodiment of the present invention, and FIG. 3 is a sectional view of the separators shown in FIG. 2. FIG. 4 is a combination sectional view of the stack shown in FIG. 2.

As shown in the drawings, the stack 10 according to the present embodiment includes a plurality of electric generators 11 adjacent to and joined to one another. Each generator 11 has a membrane electrode assembly (referred to hereinafter as the “MEA”) 12, and separators 15 tightly joined to both sides of the MEA 12.

The MEA 12 includes an anode electrode and a cathode electrode arranged on the sides of an electrolyte membrane with an active region where the electrochemical reaction of hydrogen and oxygen occurs.

The anode electrode has a catalyst layer for separating the reforming gas from the reformer 35 into hydrogen ions (protons) and electrons, and a gas diffusion layer for delivering the electrons and the reforming gas to the catalyst.

The cathode electrode has a catalyst layer for reacting the hydrogen ions and electrons delivered from the anode electrode with the oxygen in the air supplied by the operation of the fan 51, thereby generating heat and water, and a gas diffusion layer for delivering the oxygen to the catalyst.

The electrolyte membrane delivers the hydrogen ions generated from the anode electrode to the cathode electrode.

The separators 15 tightly joined to both sides of the MEA 12 act as conductors for serially connecting the anode and the cathode electrodes of the MEA 12, and allow the passage of the hydrogen and oxygen required for the oxidation and reduction of the MEA 12 to the anode and the cathode electrodes.

To accomplish the passage of hydrogen, a hydrogen passage 13a is formed at one surface of the separator 15.

To accomplish the passage of air, an air passage 14a is formed at the opposite surface of the separator 15. The air both reacts in the oxidation and reduction of the MEA 12 and acts as cooling air to dissipate the heat generated from the respective electric generators 11 during the generation of electricity by driving of the stack 10.

In this embodiment, the separator 15 is formed by the combination of a separator 14 having the air passage 14a and a separator 13 having the hydrogen passage 13a for delivering the hydrogen to the neighboring electric generator 11. For explanatory convenience, the separator for passing the hydrogen will be referred to as the first separator 13, and the separator for passing the air as the second separator 14.

The hydrogen passage 13a and the air passage 14a are formed at the side surfaces of the first and the second separators 13 and 14, and the surfaces of the separators 13 and 14 with no passage are tightly joined to each other to form a separator 15.

As the respective separators 13 and 14 have only the hydrogen passage 13a or the air passage 14a at one surface, it is unnecessary to include separate cooling channels at the respective separators 13 and 14. Furthermore, as it is possible to pass the cooling air and the reaction air through the air passage 14a without installing a separate cooling plate between the first and the second separators 13 and 14, the separator 15 may made very thin, provided that it has a reasonable rigidity.

Accordingly, when a plurality of electric generators 11 with the first and second separators 13 and 14 and the MEA 12 are arranged adjacent to and tightly joined to one another to form a stack 10, the second separator 14 with the air passage 14a directly contacts the MEA 12 so that the air from the oxygen supplier 50 is supplied to the cathode electrode of the MEA 12 while cooling the electric generator 11 when it passes through the air passage 14a.

Consequently, it is not needed to separately form a channel or a cooling plate for supplying the cooling air at the separator 15 except for the air passage 14a, and hence, the thickness of the electric generators 11 as well as the thickness of the whole stack 10 is reduced.

The air passage 14a of the second separator 14 will be now explained in detail.

The air passage 14a is formed at the surface of the second separator 14 contacting the MEA 12 such that it has a plurality of channels spaced apart from each other by a predetermined distance. The channels of the air passage 14a rectilinearly proceed from one end of the second separator 14 to the opposite end thereof.

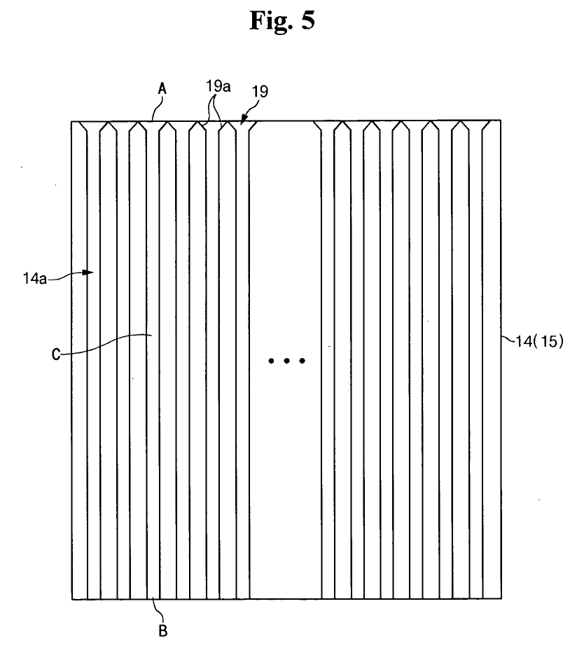

The air passage 14a contacts the MEA 12 such that both ends communicate with the outside of the stack 10. Accordingly, as shown in FIG. 5, one end of the air passage 14a forms an inlet A for the air, and the opposite end forms an outlet B for the air. A rectilinear path C is formed between and joins the inlet A and the outlet B.

Consequently, the air flows through the inlet A along the rectilinear path C to both reduce the MEA 12 and absorb the heat generated by the electric generators 11 and dissipate the heat outside of the stack 10 as the air flows through the outlet B. The sectional structure of the air passage 14a as shown is formed in the shape of a rectangle, but may be formed with various other shapes including semicircular shapes and trapezoidal shapes.

With the stack 10 according to the present embodiment, the electric generator 11 of this embodiment includes an inlet A with a sectional area of the air passage 14a that is relatively larger than the sectional area of its corresponding outlet B. This allows the air to flow more efficiently from the oxygen supplier 50 into the rectilinear path C through the inlet A, thereby enhancing the cooling capacity of the electric generator 11 and the reaction efficiency between the hydrogen and oxygen.

According to this embodiment, the electric generator 11 has a guide 19 for guiding the air supplied from the oxygen supplier 50 to the rectilinear path C of the air passage 14a.

Specifically, the guide 19 has inclined wall portions 19a formed at one end of the second separator 14 at the inlet A that incline toward the rectilinear path C of the air passage 14a such that the inlet sectional area is gradually reduced to funnel the air into the rectilinear path C. Considering that the sectional structure of the air passage 14a is rectangular-shaped, the inclined portion 19a is inclined toward the inner wall of the rectilinear path C. That is, the inlet A of the air passage 14a has a sectional area gradually reduced toward the rectilinear path C due to the guide 19, and hence, the sectional area of the inlet A is larger than the sectional area of the outlet B.

Accordingly, with the operation of the stack 10 according to the present embodiment, when the air supplied from the oxygen supplier 50 to the stack 10, it is guided by the guide 19, and is smoothly introduced into the rectilinear path C through the inlet A of the air passage 14a. The air that is supplied by the air passage 14a acts to both supply the MEA 12 with the oxygen necessary for the electrochemical reaction, and to cool the electric generator 11.

As described above, with the structure according to the present embodiment, the air flows smoothly through the air passage 14a with less pressure loss due to the guide 19 so that the cooling efficiency of the electric generator 11 is enhanced while providing the air at a higher pressure to improve the reaction efficiency of the MEA 12.

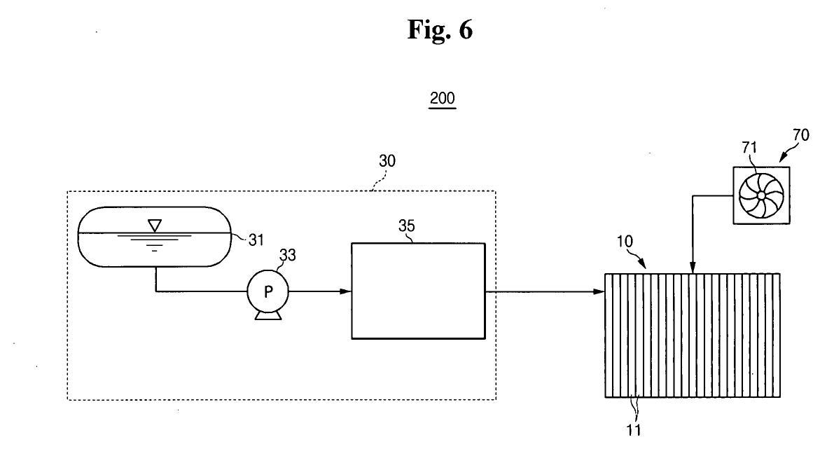

FIG. 6 is a block diagram of a fuel cell system according to another embodiment of the present invention, schematically illustrating the whole structure thereof. Explanation of the same structural components shown in FIG. 6 as those shown in FIG. 1 with like reference numerals will be omitted.

As shown in FIG. 6, the fuel cell system according to the present embodiment includes a stack 10 with electric generators 11 continually arranged to generate an electrical energy based on the electrochemical reaction of hydrogen and oxygen, a fuel supplier 30 for supplying hydrogen to the electric generators 11, and a coolant supplier 70 for supplying coolant air to the electric generators 11.

With the system according to the present embodiment, the coolant air supplied from the coolant supplier 70 partially participates in the electrochemical reaction of the electric generators 11, and hence, a separate air supplier for the oxidant is not required. In other words, the fuel cell system 200 has a coolant supplier 70 without an oxidant air supplier as was illustrated in the previous embodiment such that the oxidant and the coolant can both be supplied through the coolant supplier 70.

The coolant supplier 70 has a cooling fan 71 for supplying the coolant to the electric generators 11 with the same structure as that set forth in the previous embodiment, and the cooling fan 71 is connected to the stack 10 to supply the coolant to the stack 10. The coolant also supplies oxygen to the electric generators 11, and in this embodiment, atmospheric air is used as the coolant.

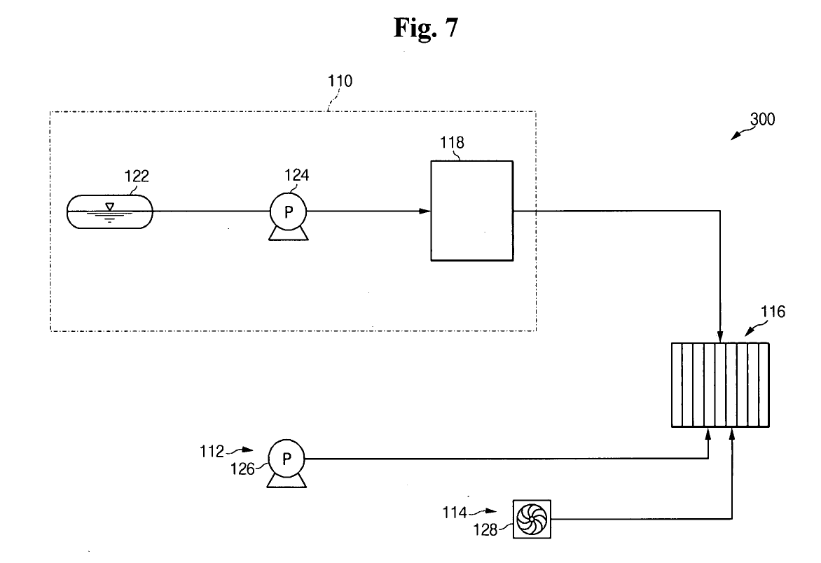

FIG. 7 is a schematic block diagram of a fuel cell system according to another embodiment of the present invention.

Unlike with the systems of the previous embodiments, with the fuel cell system 300 according to the embodiment shown in FIG. 7, hydrogen and air are supplied to a stack 116 to generate electrical energy through electrochemically reacting the hydrogen with oxygen in the air, and the heat generated from the stack 116 is dissipated by air supplied to the stack 116 in a separate manner.

For this purpose, the fuel cell system 300 includes a stack 116 for generating electrical energy based on the electrochemical reaction of hydrogen and oxygen, a fuel supplier 110 for generating hydrogen from a liquid fuel and supplying the hydrogen to the stack 116, an oxygen supplier 112 for supplying oxygen to the stack 116, and a coolant supplier 114 for supplying a cooling air to the stack 116 to dissipate the heat generated from the stack 116.

The stack 116 is connected to the fuel supplier 110 and the oxygen supplier 112 to receive hydrogen from the fuel supplier 110 and air from the oxygen supplier 112, and generates electrical energy through electrochemically reacting the hydrogen with oxygen in the air.

Similar to the structure according to the previous embodiment, the fuel supplier 110 includes a fuel tank 122 for storing a liquid fuel, a fuel pump 124 for discharging the fuel stored in the fuel tank 122, and a reformer 118 for generating a hydrogen-contained reforming gas from the fuel from the fuel tank 122 and supplying the reforming gas to the stack 116. The structure of the fuel supplier 110 is the same as that related to the previous embodiment, and hence, detailed explanation thereof will be omitted.

In this embodiment, the oxygen supplier 112 has an air pump 126 for producing air to the stack 116. The coolant supplier 114 supplies a coolant such as cooling air from the atmosphere and having a temperature lower than that of the interior of the stack 116.

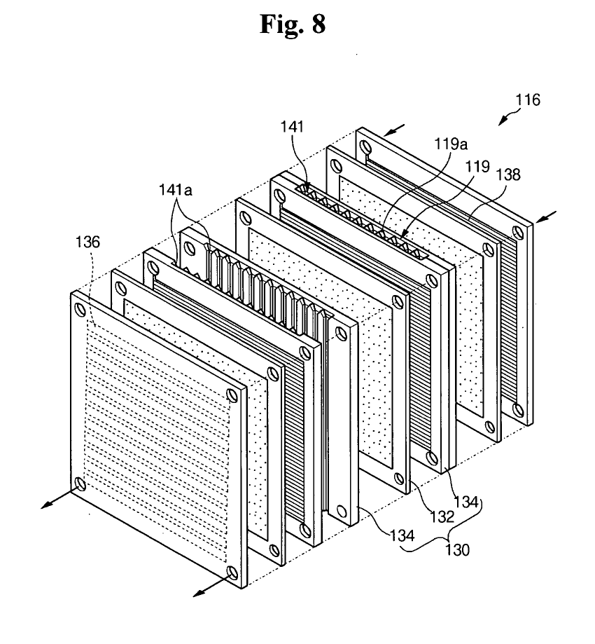

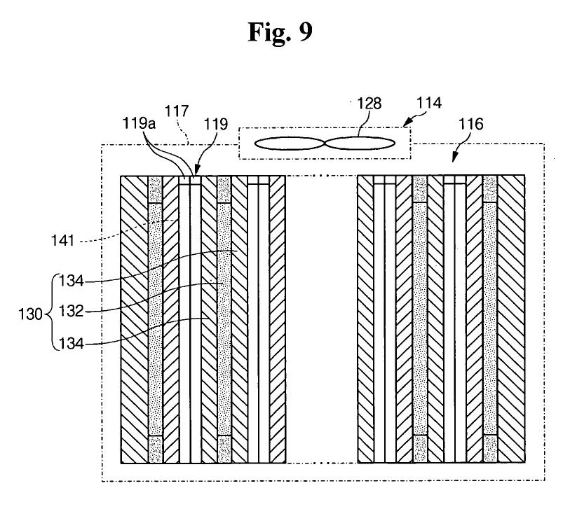

FIG. 8 is an exploded perspective view of the stack 116 shown in FIG. 7, and FIG. 9 is a combination sectional view of the stack 116 shown in FIG. 8.

The coolant supplier 114 has a fan 128 for producing air to the stack 116. As shown in FIG. 9, the fan 128 is installed in a housing 117 wholly covering the stack 116 to diffuse air over the entire area of the stack 116.

As shown in the drawings, the stack 116 according to the present embodiment has a structure assembled with a plurality of electric generators 130 each having an MEA 132 and separators 134 tightly joined to both sides of the MEA 132 to generate electrical energy.

In this embodiment, the separators 134 joined to the MEA 132 supply hydrogen and air to the anode and the cathode electrodes of the MEA 132.

A hydrogen passage 136 for supplying hydrogen gas to the anode electrode of the MEA 132 and an air passage 138 for supplying air to the cathode electrode of the MEA 132 are formed at the respective separators 134. The hydrogen passage 136 is connected to the reformer 118 of the fuel supplier 110, and the air passage 138 to the air pump 126 of the oxygen supplier 112.

With the operation of the stack 116, cooling air ventilates through the interior of the stack 116 to dissipate the heat generated from the electric generators 130. For this purpose, the stack 116 has a cooling passage 141 formed between adjacent electric generators 130 through which the cooling air flows from the coolant supplier 114 to the electric generators 130.

In this embodiment, the cooling passage 141 is formed by channels 141a formed at the surfaces of the separators 134 of adjoining electric generators 130. The channels 141a are formed at the surface of the separator 134 of one electric generator 130 opposite to the surface contacting the MEA 132, and at the surface of the separator 134 of an adjacent electric generator 130.

That is, in this embodiment, the cooling passage 141 is formed by engaging the channels 141a with each other when the separator 134 of one electric generator 130 is tightly adhered to the separator 134 of the adjacent electric generator 130.

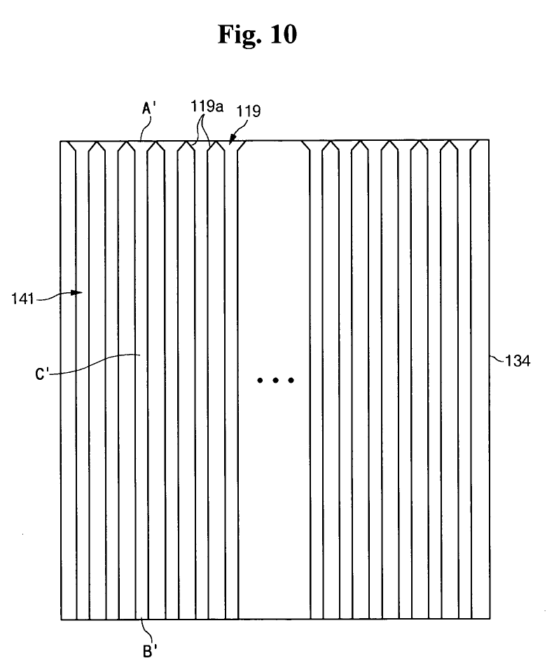

With the above-structured stack 116, as shown in FIG. 10, the cooling passage 141 has an inlet A′ formed at one end of the respective separators 134 tightly adhered to each other, an outlet C′ formed at the opposite end thereof, and a rectilinear path C′ formed between the inlet A′ and the outlet B′ to join the inlet A′ and outlet B′ to one another.

A guide 119 is provided at the stack 116 such that the air from the coolant supplier 114 can be smoothly introduced into the rectilinear path C′ through the inlet A′.

The guide 119 is formed at the inlet A′, and has an inclined portion 119a inclined toward the rectilinear path C′ of the cooling passage 141 such that the inlet sectional area is gradually reduced. Considering that the sectional structure of the cooling passage 141 is formed in the shape of a rectangle, the inclined portion 119a is inclined toward the inner wall of the rectilinear path C′. That is, the cooling passage 141 is structured such that the inlet A′ thereof is gradually reduced in sectional area toward the rectilinear path C′ due to the guide 119, and hence, the sectional area of the inlet A′ at one end of the separator 141 is larger than the sectional area of the outlet B′ at the opposite end thereof.

Consequently, with the operation of the stack 161, the air from the coolant supplier 141 is guided by the guide 119, and smoothly introduced into the rectilinear path C′ through the inlet A′ of the cooling passage 141.

According to the structure of the present embodiment, the flow of air through the cooling passage 141 is increased due to the guide 119, enhancing the cooling efficiency of the electric generators 130.

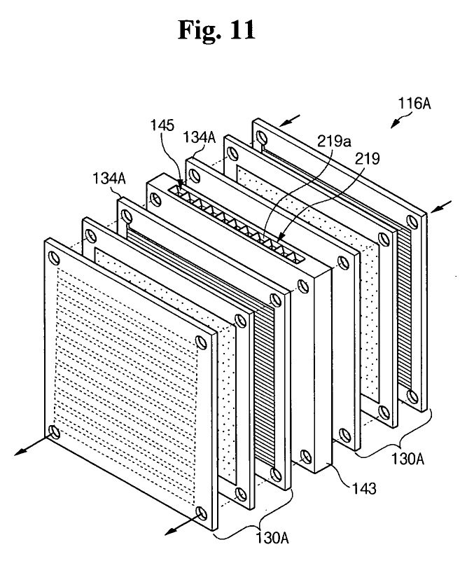

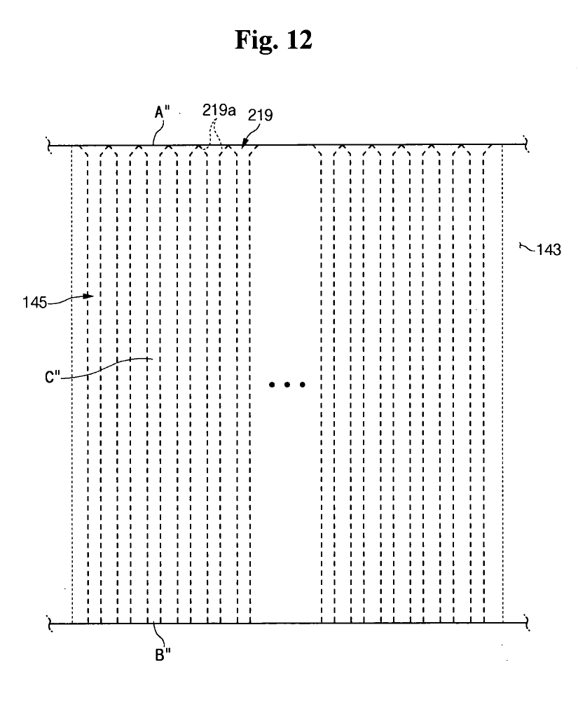

FIG. 11 is an exploded perspective view of a stack structure with a cooling plate according to another embodiment of the present invention, and FIG. 12 is a front view of the cooling plate shown in FIG. 11.

As shown in the drawings, with a stack 116A according to the present embodiment, a cooling plate 143 is installed between the adjacent electric generators 130A.

A cooling passage 145 is formed at the cooling plate 143 to permit the flow of cooling air. The cooling plate 143 acts as a heat sink for dissipating the heat transmitted to the separators 134A of the electric generators 130A during the operation thereof. The cooling plate 143 may be formed of a thermally conductive material such as aluminum, copper or iron. The cooling passage 145 proceeds from one end of the cooling plate 143 to the opposite end to permit the smooth flow of cooling air.

More specifically, the cooling passage 145 has an inlet A″ for injecting the cooling air to one end of the cooling plate 143, and an outlet B″ for discharging the cooling air from an opposite end of the cooling plate 143. Between the inlet A″ and the outlet B″ is a rectilinear path C″ allowing the inlet A″ and the outlet B″ to communicate with one another.

With the inventive structure, a guide 219 is provided at the stack 116A to smoothly introduce the air from a coolant supplier (not shown) into the rectilinear path C″ through the inlet A″.

The guide 219 is formed at the inlet A″ of the cooling passage 145, and has an inclined portion 219a inclined toward the rectilinear path C″ such that the inlet sectional area is gradually reduced. Considering that the sectional structure of the cooling passage 141 is formed in the shape of a rectangle, the inclined surface 119a is inclined toward the inner wall of the rectilinear path C″. That is, the cooling passage 145 is structured such that the inlet A″ is gradually reduced in sectional area toward the rectilinear path C″ due to the guide 219, and the sectional area of the inlet A″ is larger than the sectional area of the outlet B″.

With the operation of the stack 161, the air from the coolant supplier is guided by the guide 219, and smoothly introduced into the rectilinear path C″ through the inlet A″ of the cooling passage 145.

Consequently, with the structure according to the present embodiment, the flow of air through the cooling passage 145 is increased, enhancing the cooling efficiency of the electric generators 130A.

The remaining structural components of the stack 116A according to the present embodiment are the same as those related to the previous embodiment, and further detailed explanation is omitted.

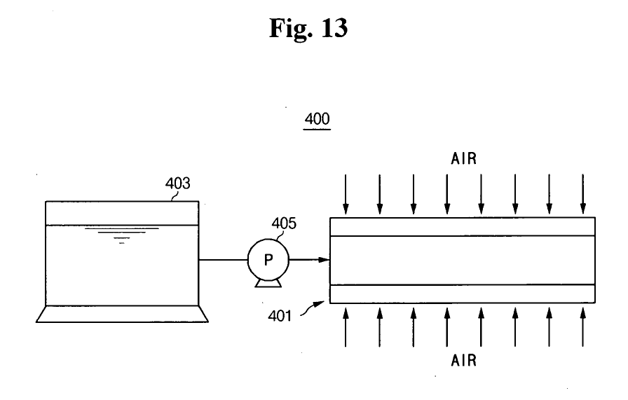

FIG. 13 is a schematic diagram of a fuel cell system 400 according to another embodiment of the present invention.

The fuel cell system 400 according to the present embodiment is of the direct oxidation fuel cell type where an alcohol-based fuel, such as methanol or ethanol, and oxygen is directly supplied, and electrical energy is generated through reacting the oxygen with the hydrogen in the fuel.

The fuel cell system 400 includes an electric generator assembly 401 having an electric generator with an MEA and anode and cathode separators placed at both sides of the MEA, a fuel tank 403 for storing a fuel such as methanol as a fuel source, and a fuel pump 405 for supplying the fuel from the fuel tank 403 to the electric generator assembly 401.

The electric generator assembly 401, the fuel tank 403 and the fuel pump 405 are not limited to any specific structure, but may bear any structures capable of producing fuel to the fuel cell. Similarly, the electric generator assembly 401 may be of any one of various configurations. For instance, the electric generator assembly 401 may have the stack structures of the previous embodiments, or other structures where a plurality of electric generators are arranged parallel to each other.

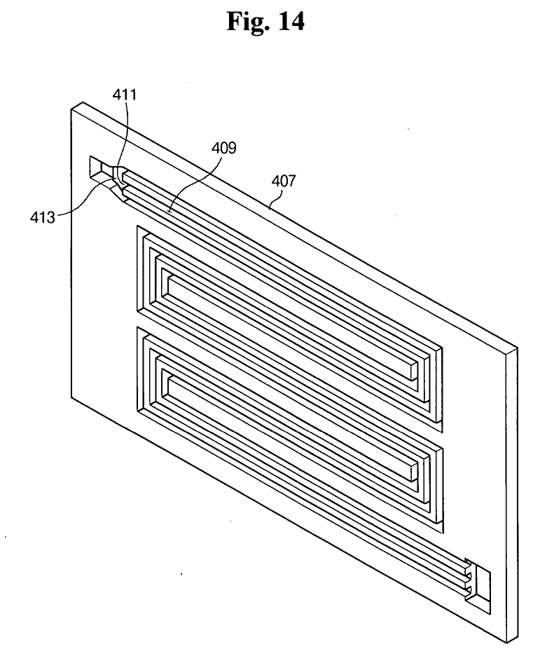

As shown in FIG. 14, the anode separator 407 has a plurality of fuel passages 409 through which the fuel flows, and a guide 413 is formed at an inlet 411 of the fuel passage 409 to guide the fuel into the passages.

The guide 413 is formed by inclining the portion of the separator 407 connected to the inlet 411. The inclination direction of the guide 413 is elevated toward the inlet 411.

That is, the guide may be formed at the fuel passage, and similar to the guides of the previous embodiments, operates to smoothly supply the fuel.

As described above, with a fuel cell system according to the present invention, oxygen and a coolant are supplied to a common passage or the coolant is supplied to a separate cooling passage to dissipate the heat generated from the stack. A guide is provided to smoothly introduce the coolant into the common passage and the cooling passage, thereby enhancing the cooling efficiency and capacity of the whole stack.

Furthermore, a guide may be formed at a fuel passage to smoothly supply the fuel, thereby enhancing the capacity of the electric generator assembly as well as the capacity of the fuel cell system.

Although preferred embodiments of the present invention have been described in detail hereinabove, it should be clearly understood that many variations and/or modifications of the basic inventive concept herein taught which may appear to those skilled in the art will still fall within the spirit and scope of the present invention, as defined in the appended claims.

What is claimed is:

1. A fuel cell stack comprising:
an electric generator for generating electrical energy through reacting hydrogen with oxygen, the electric generator including at least one common passage adapted to receive an oxidant and a coolant, the at least one common passage comprising an inlet with a first sectional area and an outlet with a second sectional area, wherein the first sectional area is larger than the second sectional area.

2. The fuel cell stack of claim 1 wherein air is provided as both the oxidant and the coolant.

3. A fuel cell stack for generating electrical energy through electrochemically reacting hydrogen with oxygen, the fuel cell stack comprising an electric generator comprising:
a membrane electrode assembly;
separators placed at both sides of the membrane electrode assembly, wherein at least one of the separators includes at least one common passage arranged at a surface of the corresponding separator and adapted to permit the flow of the oxygen and a coolant, and a guide formed at an inlet of the at least one common passage to guide the oxygen and the coolant into the corresponding common passage.

4. The fuel cell stack of claim 3 wherein air is used as both a source of the oxygen as the coolant.

5. The fuel cell stack of claim 3 wherein each common passage is formed at a surface of the corresponding separator in a channel arrangement.

6. The fuel cell stack of claim 5 wherein each common passage proceeds from one end of the corresponding separator to the opposite end.

7. The fuel cell stack of claim 3 wherein the guide comprises an inclined portion formed at the inlet.

8. A fuel cell stack comprising:
a plurality of electric generators arranged adjacent one another for generating electrical energy through electrochemically reacting hydrogen with oxygen;
a cooling passage formed between a pair of adjacent electric generators and adapted to permit a flow of a coolant; and
a guide formed at an inlet of the cooling passage to guide the coolant into the cooling passage.

9. The fuel cell stack of claim 8 adapted to use air as the coolant.

10. The fuel cell stack of claim 8 wherein each electric generator comprises a membrane electrode assembly and separators placed at both sides of the membrane electrode assembly, and the cooling passage is formed on at least one of the separators.

11. The fuel cell stack of claim 10 wherein the cooling passage is formed by engaging channels formed at a surface of one separator with channels formed at a surface of an adjacent separator.

12. The fuel cell stack of claim 8 wherein the cooling passage is defined by a cooling plate disposed between a pair of adjacent electric generators such that the cooling passage penetrates through the cooling plate.

13. The fuel cell stack of claim 8 wherein the guide comprises an inclined portion formed at the inlet.

14. An electric generator assembly for a fuel cell comprising:
a membrane electrode assembly;
separators placed at both sides of the membrane electrode assembly;
a fuel passage formed on a surface of at least one of the separators and adapted for the flow of a fuel; and
a guide formed at an inlet of the fuel passage to guide the fuel into the fuel passage.

15. The electric generator assembly for a fuel cell of claim 14 wherein the guide comprises and inclined portion of the separator connected to the inlet.

16. A fuel cell system comprising:
a stack comprising an electric generator with a membrane electrode assembly, separators placed at both sides of the membrane electrode assembly, a plurality of common passages arranged at a surface of at least one of the separators and adapted to permit the flow of oxygen and a coolant, and a guide formed at an inlet of each common passage to guide the oxygen and the coolant into the common passage;
a fuel supplier for supplying a fuel to the stack; and
an oxygen supplier for supplying oxygen to the common passage.

17. The fuel cell system of claim 16 wherein the oxygen supplier supplies air as a source of oxygen.

18. The fuel cell system of claim 17 adapted to use air as the coolant.

19. The fuel cell system of claim 16 wherein the oxygen supplier comprises a fan for supplying air to the common passage as a source of oxygen.

20. The fuel cell system of claim 16 wherein the guide comprises an inclined portion formed at the inlet.

21. A fuel cell system comprising:
a stack comprising a plurality of adjacent electric generators;
a fuel supplier for supplying a fuel to the stack;
an oxygen supplier for supplying a source of oxygen to the stack; and
a coolant supplier for supplying a coolant to the stack, wherein the stack comprises at least one cooling passage formed between adjacent electric generators and adapted to permit a flow of the coolant, and a guide formed at an inlet of the cooling passage to guide the coolant into the cooling passage.

22. The fuel cell system of claim 21 wherein each electric generator comprises a membrane electrode assembly and separators placed at both sides of the membrane electrode assembly, and the cooling passage is formed at the separator.

23. The fuel cell system of claim 22 wherein the cooling passage is formed by engaging channels formed at a surface of the separator with channels formed at a surface of an adjacent separator.

24. The fuel cell system of claim 21 further comprising at least one cooling plate disposed between adjacent electric generators, wherein the cooling passage penetrates the cooling plate.

25. The fuel cell system of claim 21 wherein the guide comprises an inclined portion formed at the inlet.

26. The fuel cell system of claim 21 wherein the coolant supplier comprises a fan for supplying air to the cooling passage.

27. A fuel cell system comprising:
the electric generator assembly of claim 14; and
a fuel supplier for supplying a fuel to the electric generator assembly.
